(19) United States
(12) Patent Application Publication
(10) Pub. No.: US 2006/0274278 A1
(43) Pub. Date: Dec. 7, 2006

(54) Illumination system capable of adjusting aspect ratio and projection system employing the illumination system

(75) Inventors: Kye-hoon Lee, Suwon-si (KR); Won-yong Lee, Suwon-si (KR); Jong-hoi Kim, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/335,707

(22) Filed: Jan. 20, 2006

(30) Foreign Application Priority Data
Jun. 2, 2005 (KR) 10-2005-0047345

(51) Int. Cl. G03B 21/18

(52) U.S. Cl. 353/53

(57) ABSTRACT

An illumination system and a projection system capable of enhancing light efficiency and contrast. The projection system includes a display panel from which light incident to a projection lens unit is controlled according to the rotation of a plurality of micromirrors and an asymmetric stop which adjusts an angle of effective light incident from the display panel. The illumination system emitting light to the projection system includes: one or more light source units each including a single or an array of light emitting devices and having a light exit surface with an aspect ratio different from an aspect ratio of the display panel; and an aspect ratio adjusting unit adjusting the aspect ratio of the light such that the aspect ratio of the light exit surface of each of the light source units can be equal to the aspect ratio of the display panel.

### CROSS-REFERENCE TO RELATED PATENT APPLICATION

This application claims the benefit of Korean Patent Application No. 10-2005-0047345, filed on Jun. 2, 2005, in the Korean Intellectual Property Office, the disclosure of which is incorporated herein in its entirety by reference.

### BACKGROUND OF THE INVENTION

1. Field of the Invention

Systems consistent with the present invention relate to an illumination system with high light efficiency and contrast, which can operate at low power using a light emitting device as a light source, and a projection system employing the illumination system.

2. Description of the Related Art

Projection systems produce an image on a display panel using light emitted from a light source and enlarge and project the image onto a screen by means of a projection lens unit, thereby satisfying viewers' demands for viewing through a large screen. Lamps are mainly used as light sources for projection systems. However, lamps are large and expensive, generate a great amount of heat, and have a short life span.

Accordingly, projection systems may employ laser sources or light emitting diodes (LEDs) instead of lamps. LEDs are inexpensive and have a long life span, and thus they can be effectively used as light sources. On the other hand, one LED does not provide enough brightness, and accordingly, a plurality of LEDs are used in the form of a package.

FIG. 1 illustrates an LED package 10 employed by a conventional projection system. Referring to FIG. 1, the conventional LED package 10 includes an LED substrate 13 and a plurality of LED chips 15 arranged at predetermined intervals on the LED substrate 13. Each of the LED chips 15 has a square shape. A deformable mirror device (DMD), which is an image display panel in a projection system, includes a plurality of micromirrors arranged in two dimensions, each of which is independently turned on or off to pivot.

FIG. 2A illustrates propagation paths of light reflected by a micromirror 30 when the micromirror 30 is turned on and turned off. For example, a display panel with an aspect ratio of 16:9 has a length of 2.3 cm in a horizontal direction and 1 cm in a vertical direction, and micromirrors installed in this chip are on micrometer scales. Since one micromirror is so small that it is measured in microns (μm), it is very difficult to precisely control the movement of the micromirror. The range of an angle at which the micromirror can pivot is limited due to the structural constraints of the DMD, and a divergence angle of light is also limited by an inclination angle of the micromirror.

When the micromirror 30 is turned on, incident light Li is incident on the micromirror 30 at an incident angle α, and then reflected by the micromirror 30 to be vertically directed toward a screen s. Here, light, which is reflected by the micromirror 30 when the micromirror 30 is turned on to be used to create an image, is referred to as effective light Le, and light, which is reflected by the micromirror 30 when the micromirror 30 is turned off to be directed away from a projection lens unit, is referred to as an ineffective light Lu. In order to prevent the incident light Li and the effective light Le from being interfered with each other, a divergence angle of the incident light Li must be within ±α. For example, when the angle α is 12°, the divergence angle of the incident light Li may be within ±12°. When the micromirror 30 is turned off, since the micromirror 30 is inclined in the opposite direction to that in the case where the micromirror 30 is turned on, the incident light Li is reflected by the micromirror 30 to propagate in a direction other than the vertical axis P. In the meantime, light reflected by a window 31, which covers the micromirror 30, is referred to as outer light Lo.

As described above, the divergence angle of the incident light Li is limited so as to prevent interference between the incident light Li and the effective light Le. FIG. 2B illustrates the incident light Li, the effective light Le, the outer light Lo, and the ineffective light Lu projected onto the same plane to show a relationship between a rotational axis C of the micromirror 30 and the effective light Le. When an axis perpendicular to the rotational axis C is a first axis (X axis) and an axis parallel to the rotational axis C is a second axis, (Y axis), the incident light Li and the effective light Le may interfere with each other along the first axis (X axis) considering the divergence angle described above with reference to FIG. 2A, but they are not interfered along the second axis (Y axis). Accordingly, the divergence angle can have a relatively large range along the second axis (Y axis). As a result, light efficiency can be enhanced by increasing the divergence angle along the second axis (Y axis) as compared to the first axis X. An elliptical stop can be used to increase the divergence angle along the second axis Y.

FIG. 3A illustrates a display panel 35 in which a plurality of micromirrors 30 are arranged in two dimensions. Referring to FIG. 3A, the rotational axis C of each of the micromirrors 30 is indicated by a dotted line. FIG. 3B comparatively illustrates light 40 illuminated by the conventional LED package as shown in FIG. 1 and effective light 42 formed by the stop of the projection lens unit. The rotational axis C of the micromirror 30 corresponds to the Y axis. When compared, since light incident on the display panel with the LED package as shown in FIG. 1 is distributed in a square fashion, a great amount of light is removed by the stop as shown in FIG. 3B, thereby lowering light efficiency.

### SUMMARY OF THE INVENTION

The present invention provides an illumination system and a projection system which can enhance light efficiency and contrast by adjusting an aspect ratio of a light exit surface of a light emitting device acting as a light source.

According to an aspect of the present invention, there is provided an illumination system emitting light to a projection system, which includes a display panel from which light incident on a projection lens unit is controlled according to the rotation of a plurality of micromirrors and an asymmetric stop which adjusts an angle of effective light incident from the display panel, the illumination system comprising: one or more light source units each including a single light emitting device or an array of light emitting devices and a light exit surface with first aspect ratio different from a second aspect ratio of the display panel; and an aspect ratio adjusting unit adjusting the aspect ratio of light emitted from the light exit surface to the second aspect ratio.

The one or more light source units is a plurality of light source units, each of the plurality of light source units including a single light emitting device chip, and one of the plurality of the light source units emits a first light at a first wavelength and another of the plurality of the light source units emits a second light at a second wavelength, the first wavelength being different from the second wavelength.

Each of the plurality of light source units includes one or more light emitting devices that are arrayed in two dimensions, and an array of collimating lenses collimating light emitted from the array of light emitting devices, and one of the plurality of the light source units emits a first light at a first wavelength and another of the plurality of the light source units emits a second light at a second wavelength, the first wavelength being different from the second wavelength.

When a horizontal length of the display panel is M, a vertical length of the display panel is N, an f-number of the asymmetric stop in a direction parallel to a rotational axis of each of the plurality of micromirrors is F_{NO1}, and an f-number of the asymmetric stop in a direction perpendicular to the rotational axis of each of the plurality of micromirrors is F_{NO2}, a ratio (a:b) of a horizontal length and a vertical length of the light exit surface of each of the one or more light source units may be given by
(a:b)=(M×f_{No1}):(N×f_{No2}).

The illumination system may further comprise a group of condenser lenses disposed between the one or more light source units and the aspect ratio adjusting unit and having 1:1 conjugating properties between an object and an image.

An aspect ratio of a light exit surface of the aspect ratio adjusting unit may be equal to the second aspect ratio of the display panel.

The aspect ratio adjusting unit may be a tapered light tunnel.

The aspect ratio adjusting unit may have a light incident face with the first aspect ratio and a light exit face with the second aspect ratio equal to that of the display panel.

The aspect ratio adjusting unit may include an anamorphic lens having 1:1 conjugating properties between an object and an image and a light tunnel having a light input surface and a light output surface which have the substantially the same shape.

The aspect ratio adjusting unit may include a right-angled prism, and a light tunnel disposed in an optical axis of light emitted from the right-angled prism and having a light input surface and a light output surface which have the same area.

The aspect ratio adjusting unit may adjust the aspect ratio of the light exit face by adjusting a length of the light exit face in a direction perpendicular to a rotational axis of each of the plurality of micromirrors.

According to another aspect of the present invention, there is provided a projection system producing an enlarged image, the projection system comprising: one or more light source units each including a single light emitting device or an array of light emitting devices and a light exit surface with a first aspect ratio different from a second aspect ratio of a display panel; an aspect ratio adjusting unit adjusting the first aspect ratio of light emitted from the one or more light source units to the second aspect ratio; the display panel including a plurality of micromirrors arranged in two dimensions and producing an image by rotating the plurality of micromirrors according to an input image signal and modulating incident light; and a projection lens unit including an asymmetric stop for adjusting an angle of effective light incident from the display panel and enlarging and projecting the image produced by the display panel onto a screen.

The stop may have an elliptical shape having a long axis parallel to the rotational axis of each of the plurality of micromirrors and a short axis perpendicular to the rotational axis of each of the plurality of micromirrors.

The display panel may have a rectangular shape having a long axis parallel to the rotational axis of each of the plurality of micromirrors.

Each of the plurality of micromirrors may have a square shape, and the rotational axis of each of the plurality of micromirrors may coincide with a diagonal direction of each of the plurality of micromirrors.

### BRIEF DESCRIPTION OF THE DRAWINGS

The above and other properties and aspects of the present invention will become more apparent by describing in detail exemplary embodiments thereof with reference to the attached drawings in which:

FIG. 1 illustrates a light emitting diode (LED) package employed by a conventional projection system;

FIG. 2A illustrates propagation paths of incident light, effective light, outer light, and ineffective light during the pivoting of a micromirror, when a deformable mirror device (DMD) is used as a display panel for displaying an image in the projection system of FIG. 1;

FIG. 2B illustrates the incident light, effective light, outer light, and ineffective light of FIG. 2A projected onto the same plane;

FIG. 3A illustrates a DMD used as a display panel;

FIG. 3B comparatively illustrates effective light formed by a stop installed in a projection lens unit and light formed by an illumination system employing the conventional LED package of FIG. 1;

FIG. 4A is a plan view of an illumination system and a projection system according to an exemplary embodiment of the present invention;

FIG. 4B is a perspective view of an aspect ratio adjusting unit of FIG. 4A;

FIG. 5A illustrates a display panel in which a plurality of micromirrors are arranged along a long axis;

FIG. 5B illustrates a display panel in which a plurality of micromirrors are arranged along a short axis;

FIG. 6 is a diagram for explaining Lagrange Invariant Law;

FIG. 7 illustrates aspect ratios of respective surfaces of the projection system of FIG. 4A;

FIG. 8 is a plan view of the illumination system of FIG. 4A including a modified aspect ratio adjusting unit;

FIG. 9 is a plan view of the illumination system of FIG. 4A including another modified aspect ratio adjusting unit;

FIG. 10A is a plan view of an illumination system and a projection system according to another exemplary embodiment of the present invention;

FIG. 10B illustrates aspect ratios of respective surfaces of the illumination system of FIG. 10A;

FIG. 11A is a plan view of the illumination system of FIG. 10A including a modified aspect ratio adjusting unit;

FIG. 11B illustrates aspect ratios of respective surfaces of the illumination system of FIG. 11A;

FIG. 12 is a plan view of the illumination system of FIG. 10A including another modified aspect ratio adjusting unit;

FIG. 13A is a plan view of an illumination system and a projection system employing a display panel disposed along a long axis;

FIG. 13B is a perspective view of an aspect ratio adjusting unit employed by the illumination unit of FIG. 13A;

FIG. 13C is a front view of the display panel employed by the illumination system of FIG. 13A; and

FIG. 14 illustrates aspect ratios of respective surfaces of the illumination system of FIG. 13A.

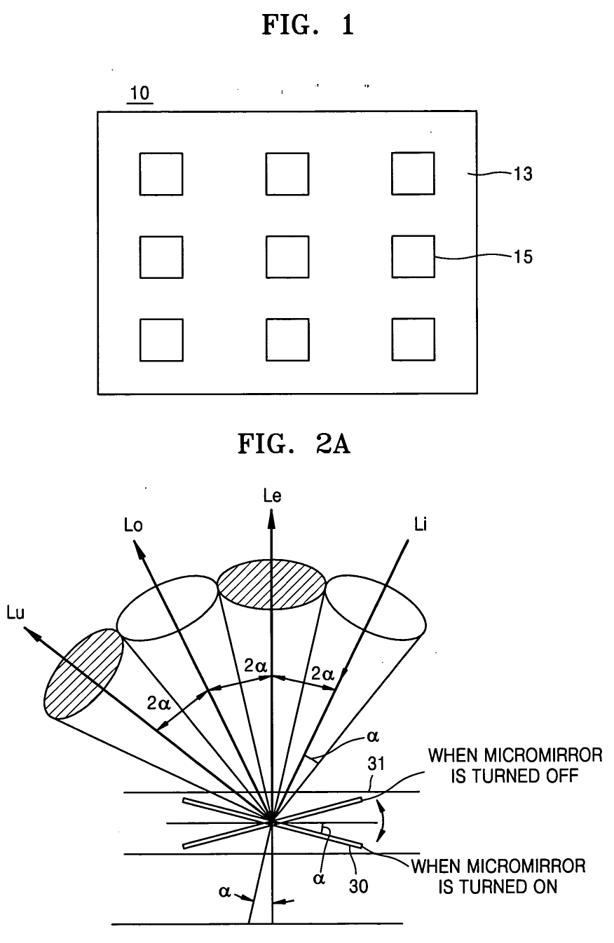

### DETAILED DESCRIPTION OF THE INVENTION

The present invention will now be described more fully with reference to the accompanying drawings, in which exemplary embodiments of the invention are shown.

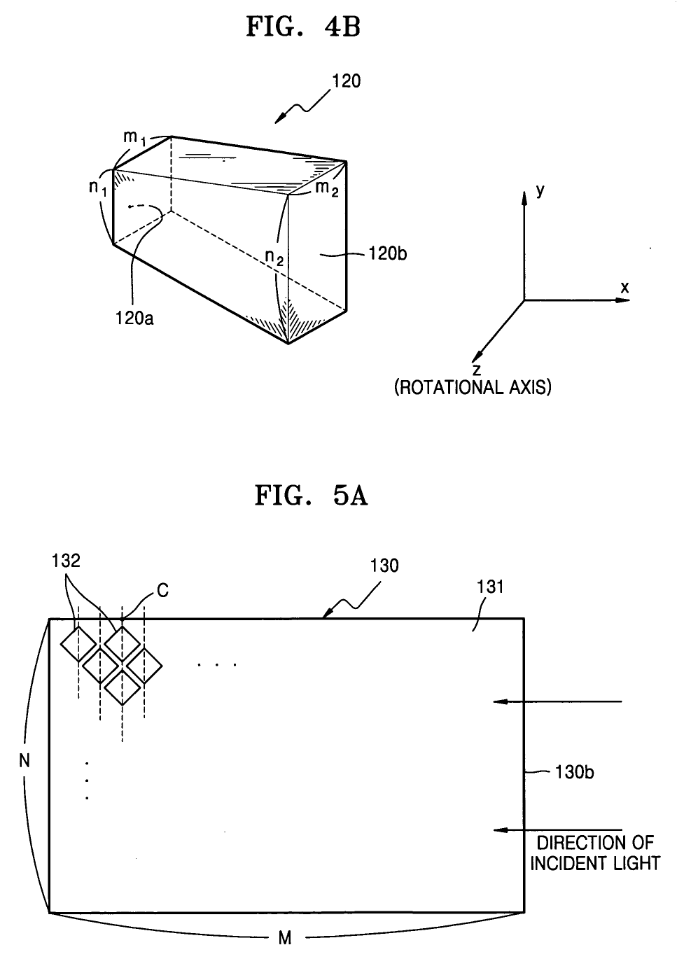

FIG. 4A is a plan view of an illumination system and a projection system according to an exemplary embodiment of the present invention. Referring to FIG. 4A, the projection system includes light source units 100a, 100b, and 100c each of which employs a light emitting device as a light source, and a display panel 130 having an aspect ratio different from that of a light exit surface of each of the light source units 100a, 100b, and 100c and producing an image using light emitted from the light source units 100a, 100b, and 100c. The illumination system emitting light to the display panel 130 also includes an aspect ratio adjusting unit 120 disposed between the light source units 100a, 100b, and 100c and the display panel 130 and changing the aspect ratio of the light exit surface of each of the light source units 100a, 100b, and 100c to conserve etendue and enhance light efficiency. Each of the light source units 100a, 100b, and 100c employs a single light emitting device chip or an array of light emitting devices as a light source, which will be explained later.

Referring to FIG. 4A, the first, second, and third light source units 100a, 100b, and 100c each comprised of a single light emitting device chip face each other, and a color combining filter 110 is disposed on a position where light emitted from the first, second, and third light source units 100a, 100b, and 100c meets together.

The first, second, and third light source units 100a, 100b, and 100c may include light emitting devices emitting light of different wavelengths, for example, light emitting diodes (LEDs) respectively emitting red light, green light, and blue light. The color combining filter 110 includes a first dichroic filter 110a and a second dichroic filter 110b, which intersect each other at right angles. The first dichroic filter 110a reflects light from the first light source unit 100a and transmits light from the other light sources 100b and 100c. The second dichroic filter 110b reflects light from the third light source unit 100c and transmits light from other the light source units 100a and 100b. The color combining filter 110 may have a cubic shape.

Light of different wavelengths emitted from the first, second, and third light source units 100a, 100b, and 100c propagates along the same path by means of the color combining filter 110 toward the aspect ratio adjusting unit 120. A group of condenser lenses 115 are disposed between the first, second, and third light source units 100a, 100b, and 100c and the aspect ratio adjusting unit 120 to 1:1 conjugate light emitted from the first, second, and third light source units 100a, 100b, and 100c to the aspect ratio adjusting unit 120. The group of condenser lenses 115 condense light emitted from the first, second, and third light source units 100a, 100b, and 100c to reduce the section of light and forward the condensed light to the aspect ratio adjusting unit 120, and may have properties of 1:1 conjugating between an object and an image. Accordingly, the group of condenser lenses 115 having the properties of 1:1 conjugating between the object and the image change a magnifying power but maintains the aspect ratio when the light emitted from the light source units 100a, 100b, and 100c is incident on the aspect ratio adjusting unit 120.

FIG. 4B is a perspective view of the aspect ratio adjusting unit 120 of FIG. 4A. Referring to FIG. 4B, the aspect ratio adjusting unit 120 may include a tapered light tunnel having a light incident surface 120a and a light exit surface 120b with an aspect ratio which is different from the aspect ratio of the light incident surface 120a. The light incident surface 120a may have the same aspect ratio as the first, second, and third light source units 100a, 100b, and 100c, and the light exit surface 120b may have the same aspect ratio as the display panel 130.

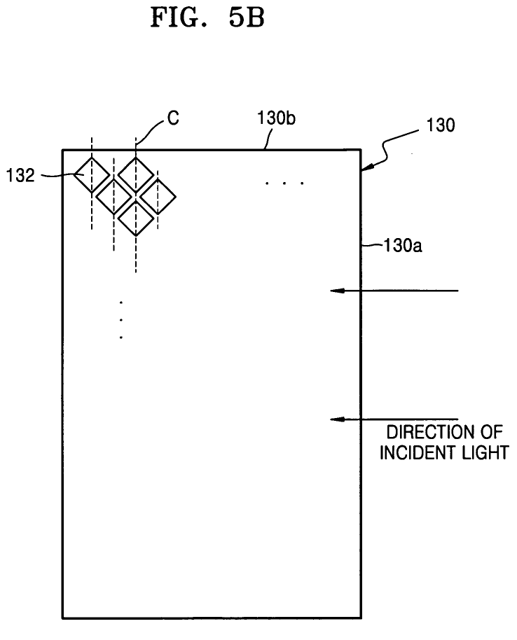

FIG. 5A illustrates the display panel 130 in which a plurality of micromirrors 132 are arranged in two dimensions. Each of the micromirrors 132 pivots about a rotational axis C. A panel 131 has a side 130b along a short axis (y axis) and a side 130a along a long axis (y′ axis) and has the same aspect ratio as a screen. The panel 131 may have an aspect ratio of 4:3 or 16:9. When the rotational axis C of each of the micromirrors 132 is parallel to the short axis (y axis) of the panel 131 as shown in FIG. 5A, the micromirrors 132 are referred to as being arranged along the short axis (y axis), and when the rotational axis C of each of the micromirrors 132 is parallel to the long axis (y′ axis) of the panel 131 as shown in FIG. 5B, the micromirrors 132 are referred to as being arranged along the long axis (y′ axis). Although the rotational axis C coincides with a diagonal direction of each of the micromirrors 132, the rotational axis C may be parallel to a side direction of each of the micromirrors 132. Irrespective of whether the micromirrors 132 are arranged along the short axis (y axis) or the long axis (y′ axis), light is incident in a direction perpendicular to the rotational axis C of each of the micromirrors 132.

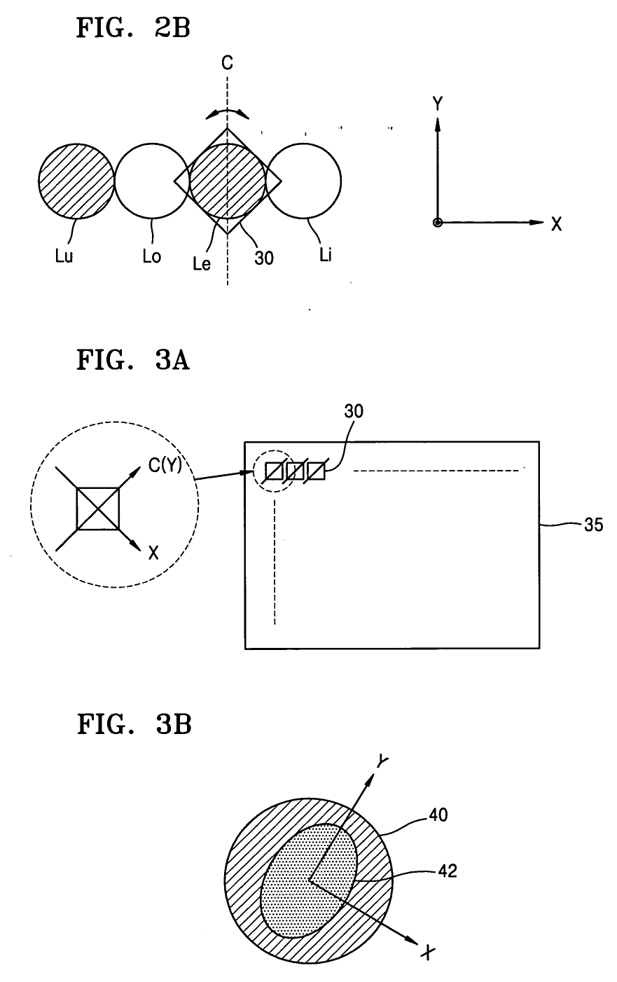

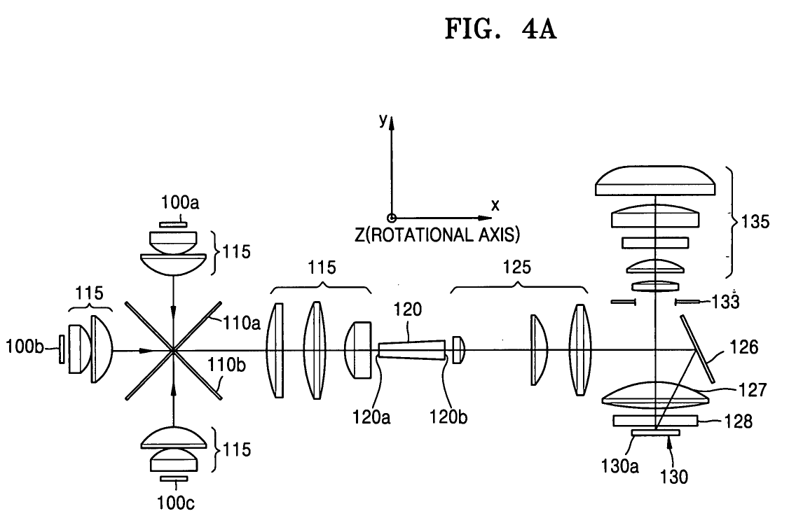

A reflecting unit 126 is disposed between the aspect ratio adjusting unit 120 and the display panel 130 to reflect light passing through the aspect ratio adjusting unit 120 to the display panel 130. The reflecting unit 126 determines an angle of light incident on the display panel 130. Since the range of the incident angle is limited as described with reference to FIG. 2A, the position of the reflecting unit 126 is also limited by the limited range of the incident angle. Consequently, the reflecting unit 126 disposed to be closely adjacent to the display panel 130 and a projection lens unit 135. In this case, light emitted from the display panel 130 to the projection lens unit 135 may interfere with the reflecting unit 126. In order to reduce the interference, the display panel 130 may be disposed along the long axis (y′ axis).

FIG. 4A illustrates the projection system employing the display panel 130 with the micromirrors 132 which are arranged along the short axis (y axis). The aspect ratio adjusting unit 120 is tapered in a direction, i.e., y direction, perpendicular to the rotational axis C, i.e., z direction, of the micromirrors 132. In other words, when the rotational axis C is a horizontal direction of a section of the aspect ratio adjusting unit (light tunnel) 120 as shown in FIG. 4B, a horizontal length m1 of the light incident surface 120a and a horizontal length m₂ of the light exit surface 120b are equal to each other (m₁=m₂) and a vertical length n2 of the light exit surface 120b is greater than a vertical length n1 of the light incident surface 120a (n₂>n1). The aspect ratio m₁:n₁ of the light incident surface 120a may be equal to the aspect ratio of the light exit surface of each of the first, second, and third light source units 100a, 100b, and 100c. The aspect ratio m₂:n₂ of the light exit surface 120b may be equal to the aspect ratio of the display panel 130.

The way of determining the aspect ratio of the light exit surface of each of the light source units 100a, 100b, and 100c to improve light efficiency will be explained in detail. The aspect ratio of the light exit surface of each of the light source units 100a, 100b, and 100c is determined according to the shape of a stop 133, which is installed in the projection lens unit 135, that is, f-number. The stop 133 has an asymmetric shape due to the limitation of the angle of light incident on the micromirrors 132. For example, the stop 133 may have an elliptical shape having a long axis parallel to the rotational axis C of each of the micromirrors 132, and a short axis perpendicular to the rotational axis C. Since f-number=(focal distance/effective aperture), an f-number difference occurs in horizontal and vertical directions when the stop 133 is asymmetric. The f-number difference can be compensated by adjusting the aspect ratio of the light exit surface of the illumination system based on Lagrange Invariant Law, which is varied for each of horizontal and vertical directions, thereby improving light efficiency and contrast.

Etendue conservation and Lagrange Invariant Law will be explained in detail for better understanding of the principle of improving light efficiency and contrast by adjusting the aspect ratio of the light exit surface of the illumination system. Etendue is a geometrical relationship of an optical system expressed with a light divergence angle and a sectional area.

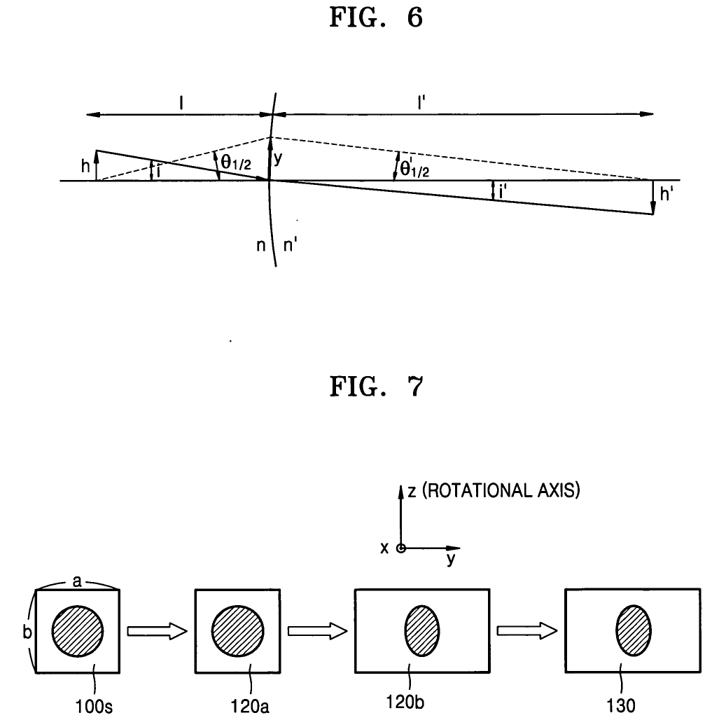

An optical system conserves etendue at a light incident surface and a light exit surface, and a light emission area and a light divergence angle are determined according to Etendue Law in the course during which light emitted from the light source units 100a, 100b, and 100c propagates through the light tunnel 120 to the display panel 130 to the projection lens unit 135. When the asymmetric elliptical stop 133 is used, however, the illumination system cannot be exactly designed with only Etendue Law. In order to design a highly efficient illumination system according to the shape of the stop 133, Lagrange Invariant Law on which Etendue Law is based should be used. Lagrange Invariant Law, which is a two dimensional equation, will now be explained with reference to FIG. 6. Here, n and n′ respectively denote refractive index of points on which an object and an image are placed, i and i′ denote incident angles of main light incident on a boundary surface, h and h′ denote sizes of the object and the image, l and l′ respectively denote distances between the object and the boundary surface and between the image and the boundary surface, y denotes a height of light incident on the boundary surface, and θ_{1/2} and θ′_{1/2} denote angles of outer light.
nsin(i)=n′sin(i′) (1)

When nh/l=n′ h′/l′ obtained using sin(i)≈h/l and sin(i′)≈n′/l′ is multiplied by y, the following equation is obtained.

$$\frac{nhy}{l} = \frac{{n}^{′} {h}^{′} y}{{l}^{′}} \qquad ( 2 )$$

Equation 2 is expressed using θ_{1/2} and θ′_{1/2} as follows.
nhsin(θ_{1/2})≈n′h′sin(θ′_{1/2}) (3)

According to Equation 3, the multiplication of a length of a side of an object surface of an optical system by a light divergence angle is almost equal to the multiplication of a length of a corresponding side of an image surface of the optical system by a light divergence angle. Here, the object surface corresponds to the incident surface 120a of the aspect ratio adjusting unit 120, and the image surface corresponds to the light exit surface 120b of the aspect ratio adjusting unit 120. The light incident surface 120a has the same aspect ratio as the light exit surface of each of the first through third light source units 100a, 100b, and 100c, and the light exit surface 120b has the same aspect ratio as the display panel 130. Accordingly, the divergence angle ratio of the light exit surface of each of the light source units 100a, 100b and 100c to the light incident surface 120a of the aspect ratio adjusting unit 120 is also constant. That is, since light emitted from the light source units 100a, 100b, and 100c is diverged in a square fashion, the divergence angle of light emitted from the light exit surface of each of the light source units 100a, 100b, and 100c is the same in horizontal and vertical directions, such that light incident on the light incident surface 120a has also a square divergence angle.

On the other side, light emitted from the display panel 130 is adjusted by the aspect ratio adjusting unit 120 to have an aspect ratio different from the aspect ratio of the light exit surface of each of the light source units 100a, 100b, and 100c, such that divergence angles of the light emitted from the display panel 160 are different in a horizontal direction (perpendicular to the rotational axis C of each of the micromirrors 132) and a vertical direction (parallel to the rotational axis C of each of the micromirrors 132). The following equation can be obtained using the above geometrical relationship and Lagrange Invariant Law.
(horizontal length of light exit surface of light source units×exiting divergence angle of light source units):(vertical length of light exit surface of light source units×divergence angle of light source units)=(horizontal length of display panel×divergence angle in direction perpendicular to rotational axis of micromirrors):(vertical length of display panel×divergence angle in direction parallel to rotational axis of micromirrors) (4).

When the exiting divergence angle of the light source units 100a, 100b, and 100c is removed from Equation 4 and the divergence angle of the micromirrors 132 is presented using an f-number of the stop 133, the following equation is obtained. A divergence angle in a direction parallel to the rotational axis C of each of the micromirrors 132 and a divergence angle in a direction perpendicular to the rotational axis C of each of the micromirrors 132 may be proportional to the effective aperture of the stop 133. Since the effective aperture of the stop 133 is inversely proportional to the f-number, when the divergence angle of light on the micromirrors 132 is substituted with the f-number of the stop 133 in Equation 4, a horizontal length of the display panel 130 is M, a vertical length of the display panel 130 is N, the f-number of the stop 133 in a direction parallel to the rotational axis C of each of the micromirrors 132 is f_{NO1}, and the f-number of the stop 133 in a direction perpendicular to the rotational axis C of each of the micromirrors 132 is f_{NO2}, the ratio a:b of horizontal and vertical lengths of the light exit surface of each of the light source units 100a, 100b, and 100c is given by
(a:b)=(M×f_{No1}):(N×f_{No2}) (5).

Etendue is conserved and light efficiency is maximized by enabling the aspect ratio of the light exit surface of each of the light source units 100a, 100b, and 100c to be dependent on the f-number of the stop 133 based on Equation 5. Contrast is also improved by controlling the divergence angle of light incident on the display panel 130 according to the shape of the stop 133.

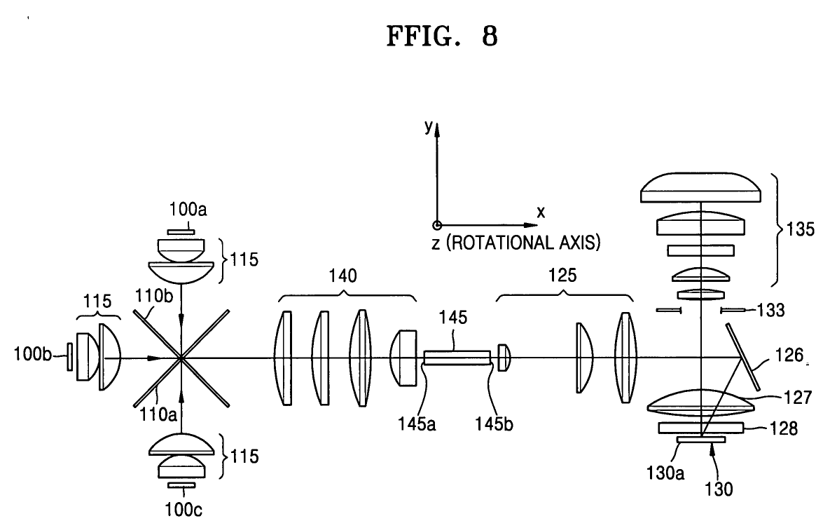

FIG. 7 illustrates aspect ratios of the light exit surface 100s of each of the first through third light source units 100a, 100b, and 100c, the light incident surface 120a and the light exit surface 120b of the aspect ratio adjusting unit 120, and the display panel 13 of the projection system of FIG. 4A. Although the light exit surface 100s of each of the light source units 100a, 100b, and 100c and the light incident surface 120a of the aspect ratio adjusting unit 120 may have the same aspect ratio and different areas, they have the same area, for convenience of explanation. Although the light exit surface 120b and the display panel 130 may have the same aspect ratio and different areas, they have the same area, for convenience of explanation. Hatched portions in the respective surfaces represent divergence angle distributions. Since the aspect ratio of the light exit surface 100s and the aspect ratio of the light incident surface 120a are equal to each other, the divergence angles of the light exit surface 100s and the light incident surface 120a are equal to each other. Since the aspect ratios of the light incident surface 120a and the light exit surface 120b of the aspect ratio adjusting unit 120 are different from each other, divergence angles of the light incident surface 120 and the light exit surface 120b are different according to Lagrange Invariant Law.

The aspect ratio adjusting unit 120 is a tapered light tunnel whose length is constant in a vertical direction (Z direction) and increases in a horizontal direction (y direction). According to Lagrange Invariant Law, as a length increases, a divergence angle decreases. Accordingly, a divergence angle of light in the y direction (perpendicular to the rotational axis C) is reduced, such that an elliptical divergence angle is produced. The aspect ratio and the divergence angle of the aspect ratio adjusting unit 120 are the same as those of the display panel 130. Since the asymmetric divergence angle distribution coincides with an effective divergence angle distribution determined by the stop 133, light efficiency is improved.

Light emitted from the light exit surface 120b with the asymmetric aspect ratio of the aspect ratio adjusting unit 120 is transmitted to the reflecting unit 126 through relay lenses 125, reflected by the reflecting unit 126 to be incident on the display panel 130, and transmitted through the projection lens unit 135 to be enlarged and projected onto the screen (not shown). Focusing lenses 127 and 128 are further disposed between the display panel 130 and the projection lens unit 135.

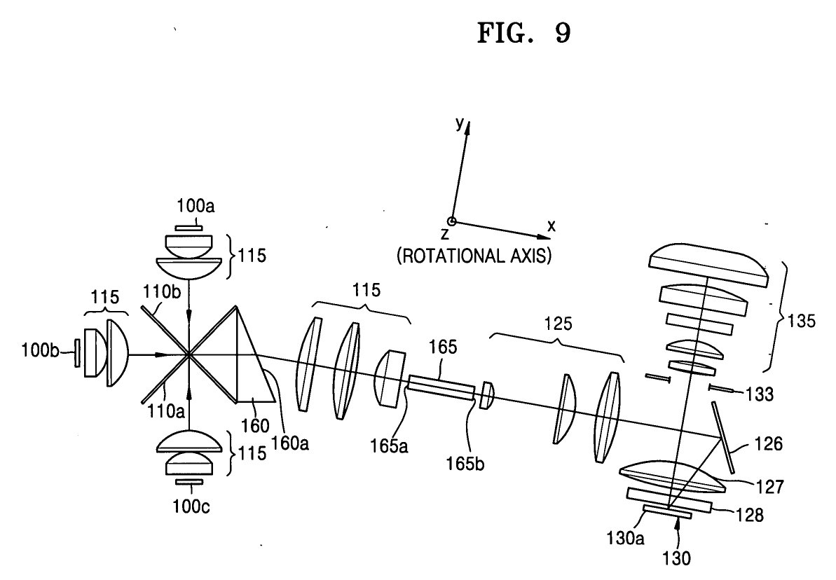

FIG. 8 is a plan view of the illumination system of FIG. 4A including a modified aspect ratio adjusting unit. Referring to FIG. 8, the aspect ratio adjusting unit includes anamorphic lenses 140 and a light tunnel, 145 having a light incident surface 145a and a light exit surface 145b which have the same shape. Other elements than the aspect ratio adjusting unit are the same as those of FIG. 4A, and thus they are designated by the same reference numerals and a detailed explanation thereof will not be given. The anamorphic lenses 140 adjust an aspect ratio by changing horizontal and vertical lengths of the light exit surface of each of the light source units 100a, 100b, and 100c and have 1:1 conjugating properties. Also, the light incident surface 145a and the light exit surface 145a of the light tunnel 145 have the same aspect ratio as the display panel 130.

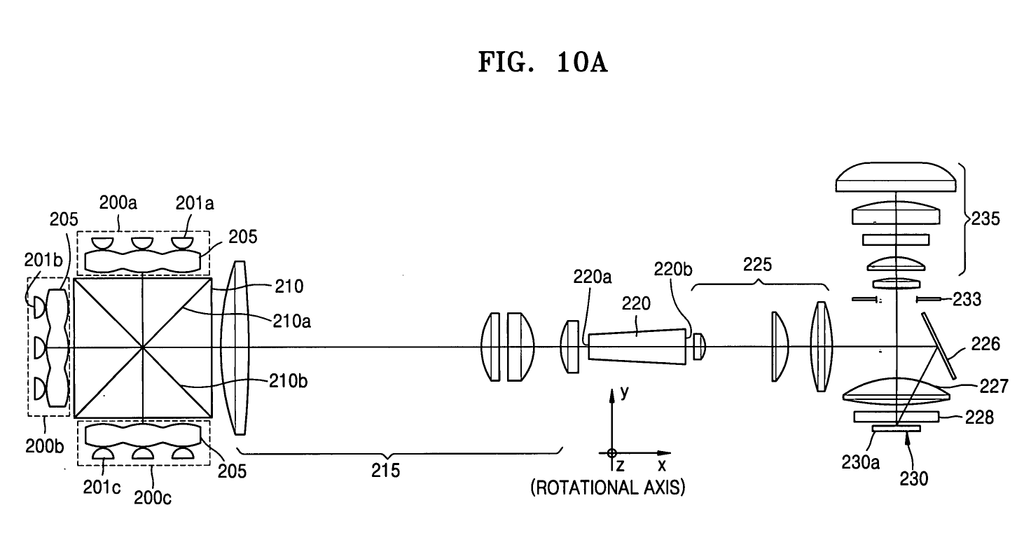

FIG. 9 is a plan view of the illumination system of FIG. 4A including another modified aspect ratio adjusting unit. Referring to FIG. 9, the aspect ratio adjusting unit includes a right-angled prism 160 disposed on a light exit surface of the color combining filter 110, and a light tunnel 165 having a light incident surface 165a and a light exit surface 165b which have the same shape. The right-angled prism 160 adjusts an aspect ratio of the light exit surface by dispersing light emitted from the light source units 100a, 100b, and 100c. The aspect ratio is adjusted by increasing a length of an oblique side 160a of the right-angled prism 160. Light whose aspect ratio is adjusted in this manner is 1:1 conjugated to the group of condenser lenses 115 to be incident on the light incident surface 165a of the light tunnel 165. The light incident surface 165a and the light exit surface 165b of the light tunnel 165 have the same aspect ratio as the display panel 130.

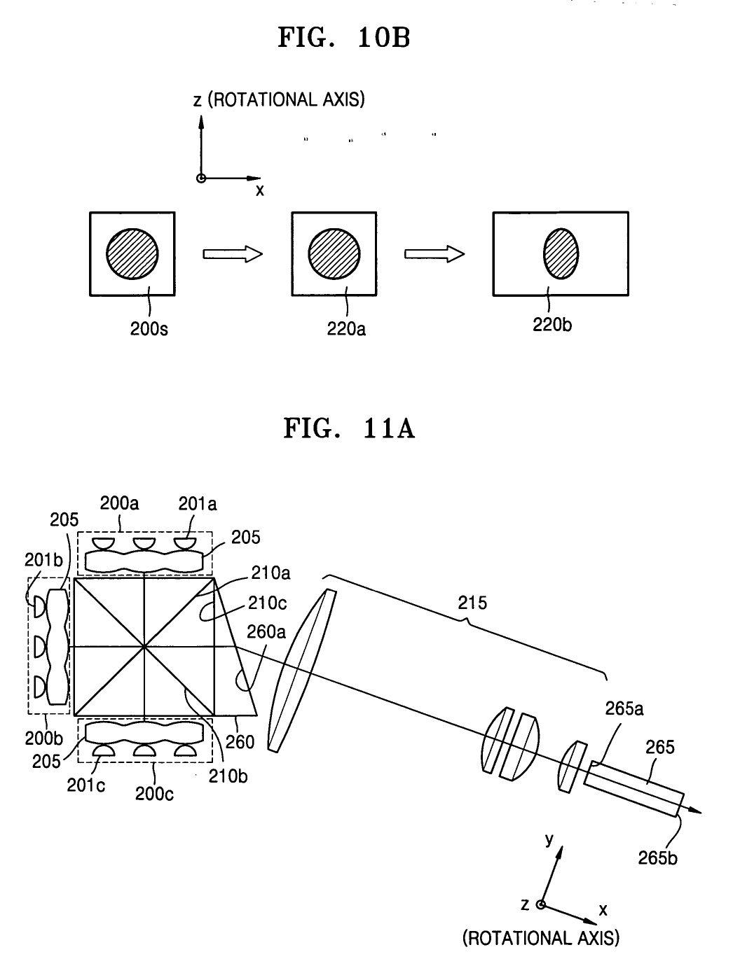

FIG. 10A is a plan view of an illumination system and a projection system according to another exemplary embodiment of the present invention. Referring to FIG. 10A, light source units 200a, 200b, and 200c respectively include light emitting devices 201a, 201b, and 201c, which are arrayed in two dimensions, and an array of collimating lenses 205 collimate light emitted from the arrays of light emitting devices 201a, 201b, and 201c. The plurality of light source units 200a, 200b, and 200c may emit light of different wavelengths. For example, the first, second, and third light source units 200a, 200b, and 200c may emit red light, green light, and blue light, respectively. The array of collimating lenses 205 includes a plurality of collimating lenses each corresponding to the array of the light emitting devices.

A color combining filter 210 combines light emitted from the first through third light source units 200a, 200b, and 200c such that the light can propagate along the same path. The color combining filter 210 includes a first dichroic filter 210a reflecting light emitted from the first light source unit 200a and transmitting light emitted from the other light source units 200b and 200c, and a second dichroic filter 210b reflecting light emitted from the third light source unit 200c and transmitting light emitted from the other light source units 200a and 200b. To produce a color image, the first through third light source units 200a, 200b, and 200c include the arrays of light emitting devices 201a, 201b, and 201c emitting light of different wavelengths. Light emitted from the first through third arrays of the light emitting devices, e.g., LEDs, 201a, 201b, and 201c is collimated by the array of collimating lenses 205 to be incident on the color combining filter 210. The color combining filter 210 includes the first dichroic filter 210a reflecting light emitted from the first array of LEDs 201a and transmitting light emitted from the other arrays of LEDs 201b and 201c, and the second dichroic filter 210b reflecting light emitted from the third array of LEDs 201c and transmitting light emitted from the other arrays of LEDs 201a and 201b. The color combining filter 210 has a cubic shape.

Light propagating along the same path due to the color combining filter 210 is incident on a aspect ratio adjusting unit 220 through a group of condenser lenses 215. The group of condenser lenses 215 1:1 conjugates light emitted from the light exit surface of each of the first through third light source units 200a, 200b, and 200c to a light incident surface 220a of the aspect ratio adjusting unit 220. The aspect ratio adjusting unit 220 includes a light tunnel having the light incident surface 220a and a light exit surface 220b, which have different aspect ratios from each other. The light incident surface 220a has the same aspect ratio as each of the first through third light source units 200a, 200b, and 200c, and the light exit surface 220b has the same aspect ratio as a display panel 230. The light exit surface of each of the light source units 200a, 200b, and 200c has an aspect ratio expressed in Equation 5.

FIG. 10B illustrates aspect ratios of respective surfaces of the illumination system of FIG. 10A. Referring to FIG. 10B, the light exit surface 200s of each of the light source units 200a, 200b, and 200c has an aspect ratio equal to that of the light incident surface 220a of the aspect ratio adjusting unit 220, but different from that of the light exit surface 220b of the aspect ratio adjusting unit 220. As the aspect ratio is changed, a divergence angle is also changed. The changed divergence angle may coincide with the effective divergence angle determined by the asymmetric stop 133 of FIG. 4A. The aspect ratio adjusting unit 220 may adjust the aspect ratio by adjusting a length in a direction perpendicular to the rotational axis C of each of the micromirrors of the display panel 230.

Light whose aspect ratio is adjusted by the aspect ratio adjusting unit 220 is transmitted to a reflecting unit 226 through relay lenses 225, and then reflected by the reflecting unit 220 to the display panel 230. An image produced by the display panel 230 is incident on a projection lens unit 235 through focusing lenses 227 and 228, and enlarged and projected onto the screen by a projection lens unit 235. The projection lens unit 235 includes the asymmetric stop 233.

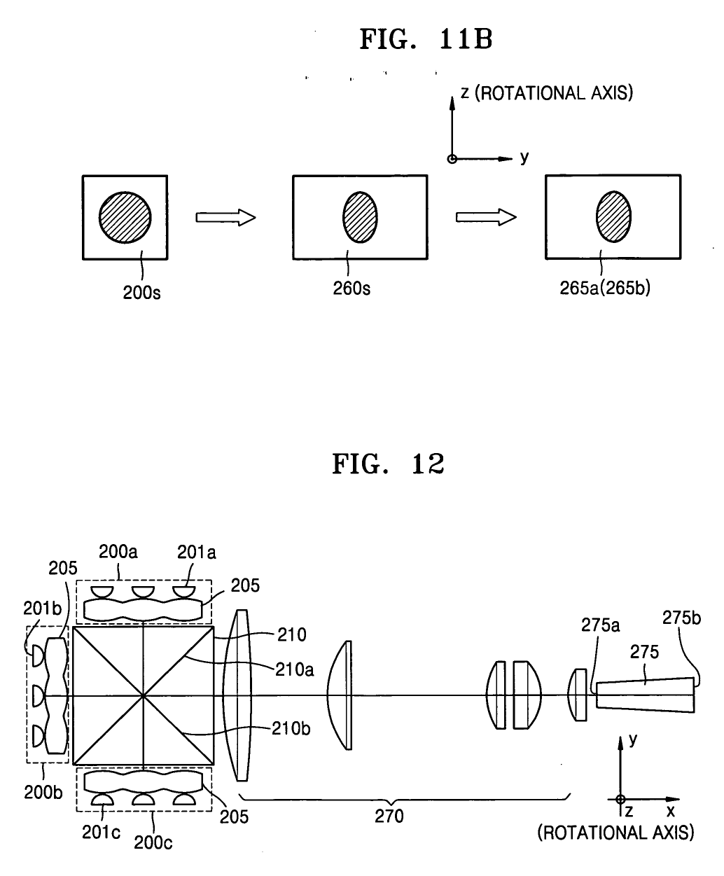

FIG. 11A is a plan view of the illumination system of FIG. 10A including a modified aspect ratio adjusting unit. The aspect ratio adjusting unit includes a right-angled prism 260 disposed on a light exit surface 210c of the color combining filter 210, and a light tunnel 265. The light tunnel 265 includes a light incident surface 265a and a light exit surface 265b which have the same shape. Light passing through the color synthesis prism 210 is dispersed by the right-angled prism 260 such that the aspect ratio of the light is changed. The light with the changed aspect ratio is transmitted through the light tunnel 265 such that the divergence angle of the light is changed. FIG. 11B illustrates aspect ratios of respective surfaces of the illumination system of FIG. 11A. Referring to FIG. 11B, the aspect ratio of the light exit surface 200s of each of the light source units 200a, 200b, and 200c is changed by the right-angled prism 260, and a divergence angle of light emitted from the light exit surface 200s is also changed. A light exit surface 260s of the right-angle prism 260, and the light incident surface 265a and the light exit surface 265b of the light tunnel 265 have the same aspect ratio.

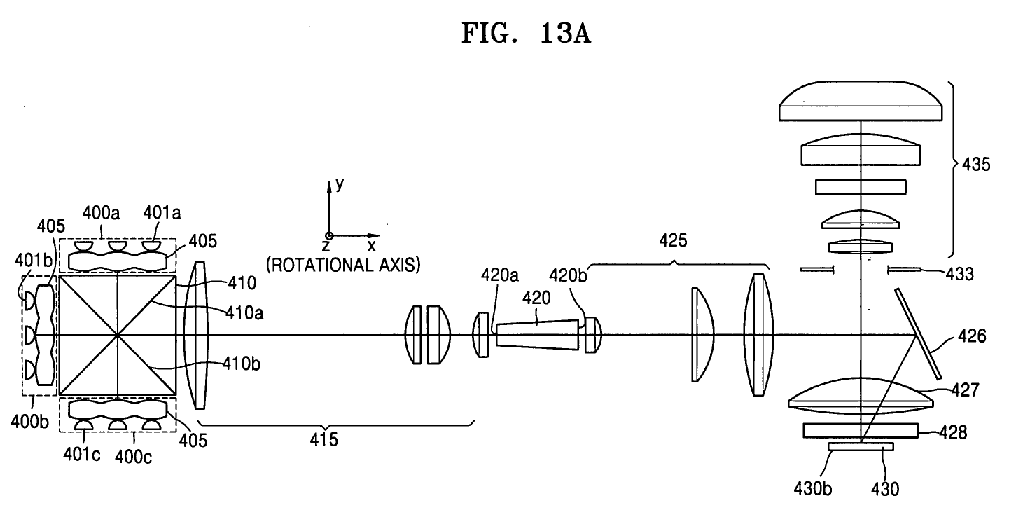

FIG. 12 is a plan view of the illumination system of FIG. 10A including another modified aspect ratio adjusting unit. The aspect ratio adjusting unit includes an anamorphic lens 270 and a light tunnel 275. The light tunnel 275 has a light incident surface 275a and a light exit surface 275b having the same aspect ratio and area. The function and operation of the anamorphic lens 270 and the light tunnel 275 are the same as described above with reference to FIG. 8, and thus a detailed description will not be given.

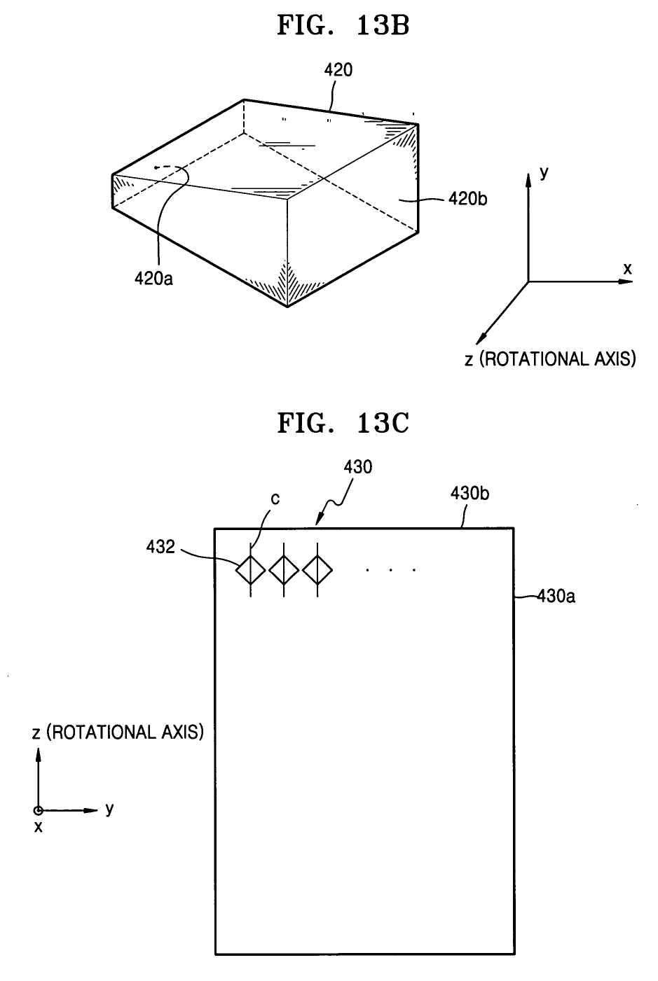

FIG. 13A is a plan view illustrating an illumination system and a projection system employing a display panel disposed along a long axis. The illumination system and the projection system include first through third light source units 400a, 400b, and 400c, which respectively include first through third arrays of light emitting devices 401a, 401b, and 401c, and an array of collimating lenses 405, and an aspect ratio adjusting unit 420 adjusting an aspect ratio of a light exit surface of each of the first through third light source units 400a, 400b, and 400c. The aspect ratio adjusting unit 420 has a light incident surface 420a and a light exit surface 420b having different aspect ratios from each other as shown in FIG. 13B.

A display panel 430 produces an image using light passing through the aspect ratio adjusting unit 420. FIG. 13C is a front view of the display panel 430 employed by the illumination system of FIG. 13A. Referring to FIG. 13C, a long axis of the display panel 430 is parallel to a rotational axis C of each of micromirrors 432. The light exit surface 420b is elongated in a horizontal direction (z direction) to correspond to the display panel 430 disposed along the long axis.

Reference numeral 410 denotes a color combining filter, 410a denotes a first dichroic filter, 410b denotes a second dichroic filter, 415 denotes a group of condenser lenses, and 425 denotes relay lenses. The function and operation of the elements are the same as described with reference to FIG. 9, and thus a detailed description thereof will not be made.

Light passing through the relay lenses 425 is incident on the display panel 430 by a reflecting unit 426, and an image produced by the display panel 430 is incident on a projection lens unit 435 through focusing lenses 427 and 428 and enlarged and projected onto a screen (not shown). The projection lens unit 435 includes an asymmetric stop 433.

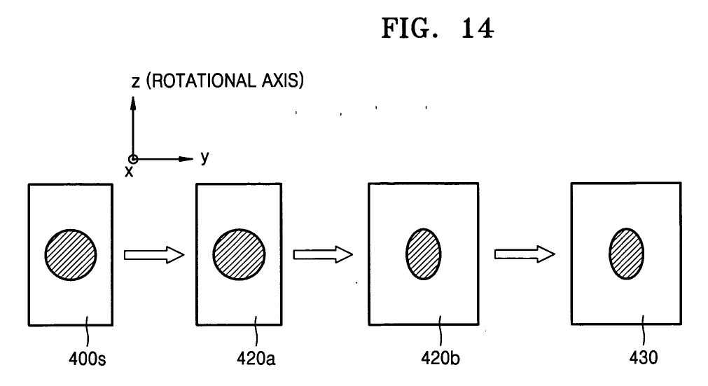

When the display panel 430 is disposed along the long axis, since a length 430b of the display panel 430 along a short axis is disposed in an optical path of light reflected by the display panel 430, interference with the reflecting unit 426 can be reduced. FIG. 14 illustrates aspect ratios and divergence angles of the light exit surface 400s of each of the light source units 400a, 400b, and 400c, the light incident surface 420a and the light exit surface 420b of the aspect ratio adjusting unit 420, and the display panel 430 disposed along the long axis.

As described above, the illumination system capable of adjusting aspect ratios and the projection system employing the illumination system use the light emitting device as a light source and the asymmetric stop to have a divergence angle coinciding with the effective divergence angle determined by the asymmetric stop and adjust an aspect ratio of the light exit surface of each of the light source units to be equal to the aspect ratio of the display panel. Consequently, light efficiency and contrast can be improved, the light emitting device can efficiently emit light at low power, and the amount of heat generated by the light emitting device can be reduced.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An illumination system emitting light to a projection system, which includes a display panel from which the light incident on a projection lens unit is controlled according to rotations of a plurality of micromirrors and an asymmetric stop which adjusts a tolerance angle of the light incident from the display panel, the illumination system comprising:
one or more light source units each comprising a single light emitting device or an array of light emitting devices and a light exit surface with a first aspect ratio different from a second aspect ratio of the display panel; and
an aspect ratio adjusting unit which adjusts the first aspect ratio of light emitted from the light exit surface to the second aspect ratio.

2. The illumination system of claim 1, wherein the one or more light source units is a plurality of light source units, each of the plurality of light source units includes a single light emitting device, and one of the plurality of the light source units emits a first light at a first wavelength and another of the plurality of the light source units emits a second light at a second wavelength, the first wavelength being different from the second wavelength.

3. The illumination system of claim 2, further comprising a color combining filter which allows lights emitted from the plurality of the light source units to propagate along a same path.

4. The illumination system of claim 1, wherein the one or more light source units is a plurality of light source units, each of the plurality of light source units comprises an array of light emitting devices that are arrayed in two dimensions, and an array of collimating lenses which collimates lights emitted from the array of light emitting devices, and one of the plurality of the light source units emits a first light at a first wavelength and another of the plurality of the light source units emits a second light at a second wavelength, the first wavelength different from the second wavelength.

5. The illumination system of claim 4, further comprising a color prism which allows the first light and the second light emitted from the plurality of light source units to propagate along a same path.

6. The illumination system of claim 1, wherein when a horizontal length of the display panel is M, a vertical length of the display panel is N, an f-number of the asymmetric stop in a direction parallel to a rotational axis of each of the plurality of micromirrors is F_{NO1}, and an f-number of the asymmetric stop in a direction perpendicular to the rotational axis of each of the plurality of micromirrors is F_{NO2}, a ratio (a:b) of a horizontal length and a vertical length of the light exit surface of each of the one or more light source units is given by:
(a:b)=(M×f_{No1}):(N×f_{No2}).

7. The illumination system of claim 1, further comprising a group of condenser lenses disposed between the one or more light source units and the aspect ratio adjusting unit and having 1:1 conjugating properties between an object and an image.

8. The illumination system of claim 1, wherein an aspect ratio of a light exit face of the aspect ratio adjusting unit is substantially equal to the second aspect ratio.

9. The illumination system of claim 1, wherein the aspect ratio adjusting unit is a tapered light tunnel.

10. The illumination system of claim 9, wherein the aspect ratio adjusting unit comprises a light incident face with the first aspect ratio and a light exit face with the second aspect ratio.

11. The illumination system of claim 1, wherein the aspect ratio adjusting unit comprises an anamorphic lens having 1:1 conjugating properties between an object and an image and a light tunnel having a light input surface and a light output surface, the light input surface and the light output surface having substantially a same shape.

12. The illumination system of claim 11, wherein each of the light input surface and the light output surface of the light tunnel has the second aspect ratio.

13. The illumination system of claim 1, wherein the aspect ratio adjusting unit comprises a right-angled prism, and a light tunnel disposed in an optical axis of light emitted from the right-angled prism and having a light input surface and a light output surface, the light input surface and the light output surface having substantially a same area.

14. The illumination system of claim 13, wherein each of the light input surface and the light output surface of the light tunnel has the second aspect ratio.

15. The illumination system of claim 1, wherein the aspect ratio adjusting unit adjusts an aspect ratio of the light exit face by adjusting a length of the light exit face in a direction perpendicular to a rotational axis of each of the plurality of micromirrors.

16. The illumination system of claim 1, further comprising relay lenses transmitting light emitted from the aspect ratio adjusting unit to the display panel.

17. A projection system producing an enlarged image, the projection system comprising:
one or more light source units each comprising a single light emitting device or an array of light emitting devices and a light exit surface with a first aspect ratio different from a second aspect ratio of a display panel;
an aspect ratio adjusting unit which adjusts the first aspect ratio of light emitted from the one or more light source units to the second aspect ratio;
the display panel comprising a plurality of micromirrors arranged in two dimensions which produces an image by rotating the plurality of micromirrors according to an input image signal and modulating incident light; and
a projection lens unit comprising an asymmetric stop which adjusts an angle of effective light incident from the display panel and enlarges and projects the image produced by the display panel onto a screen.

18. The projection system of claim 17, wherein the one or more light source units is a plurality of light source units, each of the plurality of light source units comprising a single light emitting device chip, and the one of the plurality of the light source units emits a first light at a first wavelength and another of the plurality of light source units emits a second light at a second wavelength, the first wavelength being different from the second wavelength.

19. The projection system of claim 18, further comprising:
a color combining filter which allows lights emitted from the plurality of light source units to propagate along a same path.

20. The projection system of claim 17, wherein the one or more light source units is a plurality of light source units, each of the plurality of the light source units comprises an array of light emitting devices arrayed in two dimensions and an array of collimating lenses which collimates lights emitted from the array of light emitting devices, and one of the plurality of the light source units emits a first light at a first wavelength and another of the plurality of light source units emits a second light at a second wavelength, the first wavelength being different from the second wavelength.

21. The projection system of claim 20, further comprising a color combining filter that allows the first light and the second light emitted from the plurality of light source units to propagate along a same path.

22. The projection system of claim 17, wherein when a horizontal length of the display panel is M, a vertical length of the display panel is N, an f-number of the asymmetric stop in a direction parallel to a rotational axis of each of the plurality of micromirrors is F_{NO1}, and an f-number of the asymmetric stop in a direction perpendicular to the rotational axis of each of the plurality of micromirrors is F_{NO2}, a ratio (a:b) of a horizontal length and a vertical length of the light exit surface of each of the one or more light source units is given by
(a:b)=(M×f_{No1}):(N×f_{No2}).

23. The projection system of claim 17, further comprising a group of condenser lenses disposed between the one or more light source units and the aspect ratio adjusting unit and having 1:1 conjugating properties between an object and an image.

24. The projection system of claim 17, wherein an aspect ratio of a light exit face of the aspect ratio adjusting unit is substantially equal to the second aspect ratio.

25. The projection system of claim 17, wherein the aspect ratio adjusting unit is a tapered light tunnel.

26. The projection system of claim 25, wherein the aspect ratio adjusting unit comprises a light incident face with the first aspect ratio and a light exit face with the second aspect.

27. The projection system of claim 17, wherein the aspect ratio adjusting unit comprises an anamorphic lens having 1:1 conjugating properties between an object and an image and a light tunnel having a light input surface and a light output surface, the light input surface and the light output surface having substantially a same shape.

28. The projection system of claim 27, wherein each of the light input surface and the light output surface of the light tunnel has the second ratio.

29. The projection system of claim 17, wherein the aspect ratio adjusting unit comprises a right-angled prism and a light tunnel disposed in an optical axis of light emitted from the right-angled prism and having a light input surface and a light output surface, the light input surface and the light output surface having substantially a same area.

30. The projection system of claim 29, wherein each of the light input surface and the light output surface of the light tunnel has the second aspect ratio.

31. The projection system of claim 17, wherein the aspect ratio adjusting unit adjusts an aspect ratio of the light exit face by adjusting a length of the light exit face in a direction perpendicular to a rotational axis of each of the plurality of micromirrors.

32. The projection system of claim 17, wherein the asymmetric stop has an elliptical shape having a long axis parallel to a rotational axis of each of the micromirrors and a short axis perpendicular to the rotational axis of each of the micromirrors.

33. The projection system of claim 17, wherein the display panel has a rectangular shape having a long axis parallel to a rotational axis of each of the plurality of micromirrors.

34. The projection system of claim 33, wherein each of the plurality of micromirrors has a square shape, and the rotational axis of each of the plurality of micromirrors coincides with a diagonal direction of each of the plurality of micromirrors.

35. The projection system of claim 17, further comprising relay lenses disposed between the aspect ratio adjusting unit and the display panel, wherein the relay lenses transmit light emitted from the aspect ratio adjusting unit to the display panel.

36. The projection system of claim 17, further comprising a reflecting unit reflecting light emitted from the aspect ratio adjusting unit to the display panel.
